(19) United States
(12) Patent Application Publication
(10) Pub. No.: US 2025/0130181 A1
(43) Pub. Date: Apr. 24, 2025

(54) RADIATION IMAGING APPARATUS, RADIATION IMAGING SYSTEM, METHOD OF CONTROLLING RADIATION IMAGING APPARATUS, AND MEDIUM

(71) Applicant: CANON KABUSHIKI KAISHA, Tokyo (JP)

(72) Inventor: NAOTO SHIBATA, Kanagawa (JP)

(21) Appl. No.: 18/915,859

(22) Filed: Oct. 15, 2024

(30) Foreign Application Priority Data
Oct. 19, 2023 (JP) 2023-180176

(51) Int. Cl. G01N 23/04; G01N 23/083

(52) U.S. Cl. CPC G01N 23/04; G01N 23/083; G01N 2223/401; G01N 2223/643

(57) ABSTRACT

A radiation imaging apparatus includes: a radiographic image acquisition unit for acquiring radiographic image data of a plurality of objects in a mode selected from a plurality of modes for acquiring different radiographic images; an offset image acquisition unit for acquiring offset image data in each of the plurality of modes; and an offset correction unit for executing offset correction of the acquired radiographic image data with use of the acquired offset image data, a mode storage portion for storing a mode selected in order to acquire the radiographic image data of the plurality of objects, and an offset image update control unit for controlling the offset image acquisition unit so that the offset image data to be used for the offset correction is acquired in the stored mode are provided.

### BACKGROUND OF THE INVENTION

### Field of the Invention

The present disclosure relates to a radiation imaging apparatus, a radiation imaging system, a method of controlling a radiation imaging apparatus, and a medium.

### Description of the Related Art

Currently, a radiation imaging apparatus that uses a flat panel detector formed of semiconductor materials is popular as an imaging apparatus for medical diagnostic imaging and non-destructive inspection that use radiation. This type of radiation imaging apparatus is used as, in medical diagnostic imaging, for example, a digital imaging apparatus for still-image photography such as plain radiography and moving image photography such as fluoroscopic radiography. In industrial diagnostic imaging, this type of radiation imaging apparatus is used for still image photography and CT photography of a semiconductor substrate as well.

A radiographic image generated by the radiation imaging apparatus includes not only a component corresponding to incident radiation but also a component corresponding to a dark charge. There has been known a correction method in which, in order to remove the component corresponding to a dark charge, an image acquired with the radiation imaging apparatus being irradiated with no radiation (hereinafter referred to as “offset image”) is subtracted from the radiographic image. An internal temperature of the radiation imaging apparatus fluctuates depending on a time elapsed since the radiation imaging apparatus is put into operation, and a quantity of generated dark charges fluctuates depending on the internal temperature. Accordingly, when there is a time lag between acquisition of the offset image and acquisition of the radiographic image, removal of an offset component in a suitable manner may not be executable.

In Japanese Patent Application Laid-Open No. 2013-118983, there is disclosed a method in which, in order to execute appropriate offset correction, order of updating the offset image is changed to suit a method of testing, and a time elapsed since an update is measured to determine whether the offset image is required to be updated.

In order to execute the offset correction described above in a radiation imaging apparatus that has a plurality of photography modes, it is preferred to update the offset image in every photography mode right before photographing. However, in a case in which there are many photography modes and the offset image of every photography mode is to be updated, acquisition of the offset image takes time and may cause a wait for photographing. Or, in a case of a short photographing interval, next photographing is started in the middle of an update of the offset image, and updating of the offset image may consequently fail for some photography modes. The method disclosed in Japanese Patent Application Laid-Open No. 2013-118983 takes the time elapsed since an update of the offset image into consideration, but has no consideration for those times required to update the offset image.

### SUMMARY OF THE INVENTION

In view of the problem described above, one of objects of the present disclosure is to provide a radiation imaging apparatus, a radiation imaging system, and a method of controlling a radiation imaging apparatus which are capable of offset correction using an offset image that is updated suitably even when a time available for acquisition of the offset image is limited, as well as a program that causes execution of the method.

In order to solve the problem described above, a radiation imaging apparatus according to one embodiment of the present disclosure includes: a radiographic image acquisition unit configured to acquire radiographic image data of a plurality of objects in a mode selected from a plurality of modes for acquiring different radiographic images; an offset image acquisition unit configured to acquire offset image data in each of the plurality of modes; an offset correction unit configured to execute offset correction of the acquired radiographic image data with use of the acquired offset image data; a mode storage portion configured to store a mode selected in order to acquire the radiographic image data of the plurality of objects; and an offset image update control unit configured to control the offset image acquisition unit so that the offset image data to be used for the offset correction is acquired in the stored mode.

According to one embodiment of the present disclosure, it is possible to execute offset correction using an offset image that is updated suitably even when a time available for acquisition of the offset image is limited.

Further features of the present invention will become apparent from the following description of exemplary embodiments with reference to the attached drawings.

### BRIEF DESCRIPTION OF THE DRAWINGS

FIG. 1 is a diagram for illustrating a configuration example of a radiation imaging system according to one mode of the present disclosure.

FIG. 2 is a diagram for illustrating a configuration example of a radiation detection unit in a radiation imaging apparatus.

FIG. 3 is a diagram for illustrating a configuration example of a radiographic testing apparatus.

FIG. 4 is a flow chart for illustrating a flow of processing according to a first embodiment of the present disclosure.

FIG. 5 is a table for showing mode information of the radiation imaging apparatus of the present disclosure.

FIG. 6 is a flow chart for illustrating a flow of processing according to a second embodiment, in a case in which a different photography mode is used for each different object.

FIG. 7 is a flow chart for illustrating a flow of processing according to a third embodiment, in a case in which selecting an offset image is enabled.

### DESCRIPTION OF THE EMBODIMENTS

Embodiments of the present disclosure are described in detail below with reference to the attached drawings. The embodiments described below do not limit the present invention set forth in the appended claims. A plurality of features are described in the embodiments, but the present invention does not necessarily require all of those plurality of features, and a plurality of features may be combined as appropriate. Further, in the attached drawings, the same or similar components are denoted by the same reference symbols, and redundant description thereof is omitted.

In the following embodiments, a radiation imaging system using an X-ray as an example of radiation is described. However, the radiation imaging system according to the present disclosure may use other types of radiation. The term “radiation” here may include, for example, electromagnetic radiation such as an X-ray and a y-ray, as well as particle radiation such as an a-ray, a B-ray, a particle ray, a photon ray, a heavy ion ray, and a meson ray.

### First Embodiment

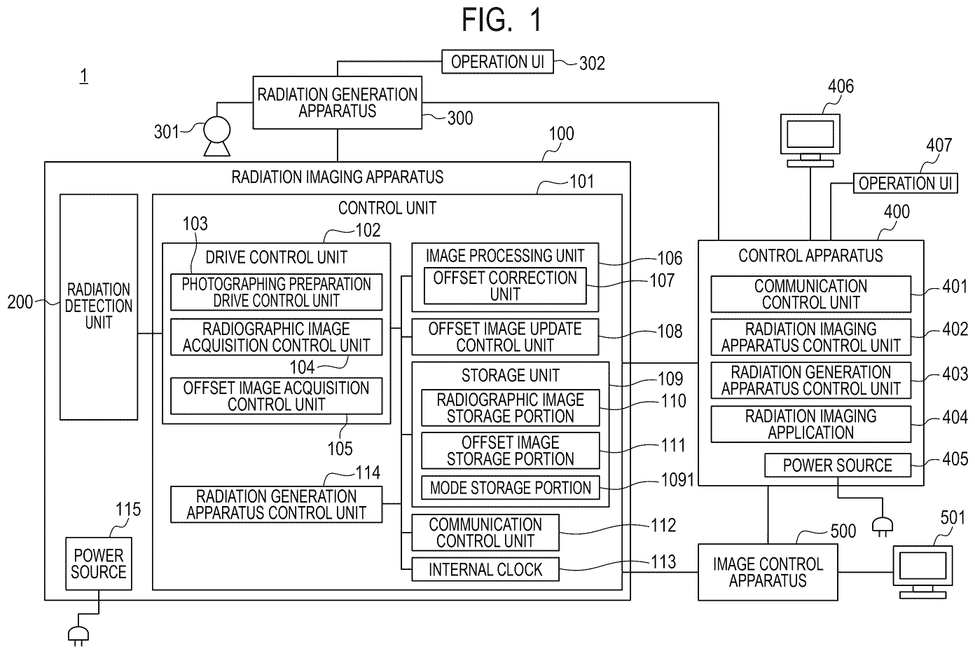

A radiation imaging apparatus, a radiation imaging system, and a method of controlling a radiation imaging apparatus according to a first embodiment of the present disclosure are described below with reference to FIG. 1 to FIG. 5. FIG. 1 is illustration of an example of a configuration of a radiation imaging system 1 according to this embodiment. The radiation imaging system 1 includes a radiation imaging apparatus 100, a radiation generation apparatus 300, a radiation source 301, a control apparatus 400, and an image control apparatus 500. The radiation imaging apparatus 100 includes a radiation detection unit 200. The radiation generation apparatus 300 controls the radiation source 301 which radiates radiation. The control apparatus 400 includes a radiation imaging application 404 which controls the radiation imaging apparatus 100 and the radiation generation apparatus 300, which collects and displays a picked-up image from the radiation imaging apparatus 100, and which is capable of receiving imaging order and registering photographing information. The image control apparatus 500 outputs, to the control apparatus 400, a picked-up image output from the radiation imaging apparatus 100.

The radiation imaging apparatus 100 includes the radiation detection unit 200 which detects radiation and generates image data, a control unit 101 which controls photographing and communication operation, and a power source unit 115. The control unit 101 includes a drive control unit 102, an image processing unit 106, an offset image update control unit 108, a storage unit 109, a communication control unit 112, an internal clock 113, and a radiation generation apparatus control unit 114. The drive control unit 102 controls driving of the radiation detection unit 200, and acquisition of a radiographic image and an offset image. The image processing unit 106 executes image processing on an image acquired from the radiation detection unit 200. The offset image update control unit 108 executes, among others, timing control of offset image update, and determination on whether an image used for offset correction is suitable. The storage unit 109 stores acquired image data. The communication control unit 112 controls communication to and from the control apparatus 400, and communication to and from the radiation generation apparatus 300. The internal clock 113 acquires a photographed time, an elapsed time, and the like. The radiation generation apparatus control unit 114 controls irradiation timing based on an irradiation signal of radiation of the radiation generation apparatus 300.

The control unit 101 reads, for example, a program stored in the storage unit 109 and executes overall control of the radiation imaging apparatus 100 based on the program. The control of the radiation imaging apparatus 100 may be executed through apparatus control by a control signal generation circuit such as an ASIC, or may be implemented by a combination of a program and a control circuit.

The radiation generation apparatus 300 includes an operation user interface (UI) 302 for operating the radiation generation apparatus 300. Use of the operation UI 302 enables a user to set a radiation irradiation condition and give an instruction about radiation irradiation. This embodiment is configured so that information can be exchanged between the radiation generation apparatus 300 and the radiation imaging apparatus 100 through a dedicated signal line. This dedicated signal line is used for exchanges of synchronization signals between the radiation generation apparatus 300 and the radiation imaging apparatus 100, with regards to notification of start and end of radiation irradiation, notification of timing at which radiation irradiation is executable, and the like.

The control apparatus 400 includes a communication control unit 401, a radiation imaging apparatus control unit 402, a radiation generation apparatus control unit 403, and a power source 405. The communication control unit 401 controls communication to and from the radiation imaging apparatus 100, to and from the radiation generation apparatus 300, and to and from, for example, an in-hospital local area network (LAN) (not shown). The radiation imaging apparatus control unit 402 controls image acquisition timing, an image acquisition condition, and the like of the radiation imaging apparatus 100. The radiation generation apparatus control unit 403 controls a radiation irradiation condition and the like of the radiation generation apparatus 300. The power source 405 functions as, for example, a main power source of the control apparatus 400.

The control apparatus 400 also includes the above-mentioned radiation imaging application 404 which controls the radiation imaging apparatus 100 and the radiation generation apparatus 300, and which is capable of acquisition and display of a picked-up image from the radiation imaging apparatus 100 as well as reception of photographing order and registration of photographing information. A display unit 406 for displaying the picked-up image and the photographing information and an operation UI (a keyboard, a mouse, and the like) 407 for operating the radiation imaging application 404 may be connected to the control apparatus 400.

Exchanges of information are executable between the control apparatus 400 and the radiation imaging apparatus 100, and between the control apparatus 400 and the radiation generation apparatus 300. Those exchanges of information are enabled, for example, by one or a plurality of measures out of cable connection communication using such standards as RS232C, USB, and Ethernet, a dedicated signal line, and wireless communication. Control communication including, for example, acquisition of image data, setting of an image acquisition condition, and acquisition of information about an apparatus state, is executed between the control apparatus 400 and the radiation imaging apparatus 100. Control communication including, for example, setting of a radiation irradiation condition, acquisition of information about an apparatus state, and acquisition of actual irradiation information, is executed between the control apparatus 400 and the radiation generation apparatus 300.

The image control apparatus 500 executes image processing of an image transferred from the radiation imaging apparatus 100, and transfers the processed image to the control apparatus 400. A display unit 501 is further connected to the image control apparatus 500, and the display unit 501 is used when, for example, the control apparatus 400 is down, to display an image output from the radiation imaging apparatus 100.

Although being described as separate components in the example, the control apparatus 400 and the image control apparatus 500 may be configured as an integrated component. The control apparatus 400 and the image control apparatus 500 are each configurable from a computer provided with a processor and a memory. The control apparatus 400 and 500 may be configured from general computers, or from computers specific to a radiograph system. The control apparatus 400 and 500 may be integrated with the display unit 406 and the operation UI 407 into a single personal computer (PC).

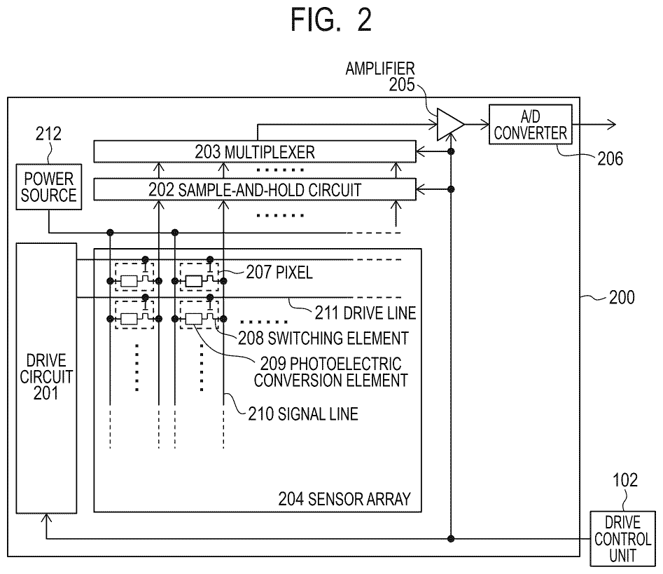

The radiation detection unit 200 is described next. FIG. 2 is illustration of an example of a configuration of the radiation detection unit 200. The radiation detection unit 200 includes a sensor array 204 built from a plurality of pixels arranged in a pattern of a two-dimensional array so as to form a plurality of rows and a plurality of columns. Each pixel 207 in the sensor array 204 is configured from a switching element 208 and a photoelectric conversion element 209 which are, for example, TFTs. A phosphor, for example, is provided in each pixel 207. Radiation incident on the radiation detection unit 200 is converted by the phosphor into visible light, the visible light resulting from the conversion enters the photoelectric conversion element 209 of each pixel, and an electric charge depending on the visible light is generated in each photoelectric conversion element 209.

This embodiment gives a description on a case of configuring the radiation detection unit 200 in the form of a so-called indirect conversion type which converts incident radiation into an electric charge with use of the above-mentioned phosphor and photoelectric conversion element. However, the radiation detection unit 200 may be configured in, for example, the form of a so-called direct conversion type in which no phosphor is provided and incident radiation is directly converted into an electric charge. The radiation detection unit 200 executes accumulation of electric charges and reading of electric charges by switching the switching element 208 on and off, and a radiographic image can thus be acquired.

In the two-dimensional sensor array 204 of the radiation detection unit 200, a drive line 211 is arranged for every row of pixels and is connected to each pixel 207 in the row, and the pixel 207 is connected to a drive circuit 201 via the drive line 211. The drive circuit 201 applies a switch-on voltage of the TFT to the drive line 211 for one row of pixels 207, to thereby switch on the switching element 208 of each pixel 207 in the one row. Electric charges accumulated in the pixels 207 are thus discharged through a signal line 210 of each pixel 207 to be held in a sample-and-hold circuit 202. The held electric charges output from the pixels are then sequentially read via a multiplexer 203, and amplified by an amplifier 205. The amplified electric charges are converted by an A/D converter 206 into image data having digital values.

In each pixel 207 in a row for which the reading of electric charges has finished, the switching element 208 of each pixel in the row is switched off by application of a switch-off voltage of the TFT from the drive circuit 201 to the drive line 211 associated with the row. Thus, each pixel 207 in the row to which a bias voltage is applied by a power source 212 returns to a state in which accumulation of electric charges is executed. In this manner, the drive circuit 201 sequentially drives and scans rows in the sensor array 204, and electric charges as output from every pixel 207 are ultimately converted into a digital value. Radiographic image data can thus be read. Control of the drive operation, the reading operation, and the like of the detection unit is executed by the drive control unit 102. The image data converted into digital values is stored in the storage unit 109 in FIG. 1.

Referring back to FIG. 1, a mode of the drive control unit 102 in this embodiment is described next. The drive control unit 102 includes a photographing preparation drive control unit 103, a radiographic image acquisition control unit 104, and an offset image acquisition control unit 105. The photographing preparation drive control unit 103 causes the radiation detection unit 200 to make preparations so that radiographing by the radiation imaging apparatus 100 is ready. The radiographic image acquisition control unit 104 uses the radiation detection unit 200 to acquire image data to be used in generation of a radiographic image. The offset image acquisition control unit 105 executes, when acquiring an offset image, control for switching an offset image to be acquired, depending on a photography mode described later.

The photographing preparation drive control unit 103 applies a voltage that is the same as a voltage used in photographing to the radiation detection unit 200, and concurrently executes periodic reading of electric charges to reset dark charges accumulated in each pixel. The electric charges read in the reset may be handled as non-image data, and storing of those electric charges in the storage unit 109 may be omitted. The radiographic image acquisition control unit 104 executes, for the radiation detection unit 200, drive control that is the same as the photographing preparation drive control, and concurrently causes each pixel in the state of accumulating electric charges to be irradiated with radiation. The radiographic image acquisition control unit 104 uses the radiation irradiation to read image data accumulated in the radiation detection unit 200, and causes the read image data to be stored as a radiographic image in a radiographic image storage portion 110 of the storage unit 109. Execution of this drive control of the radiation detection unit 200 by the radiographic image acquisition control unit 104 in succession enables photographing of radiographic images as a moving image.

The offset image acquisition control unit 105 also executes, for the radiation detection unit 200, drive control that is the same as the drive control by the photographing preparation drive control unit 103, and concurrently reads image data out of the radiation detection unit 200 without radiation irradiation. The read image data is stored as an offset image in an offset image storage portion 111 of the storage unit 109.

For a radiographic image acquired from the radiation detection unit 200 in photographing, an offset correction unit 107 of the image processing unit 106 executes offset correction processing with use of an offset image acquired in advance when there is no photographing taking place. The radiographic image processed by the offset correction processing is transferred via the communication control unit 112 to the image control apparatus 500. Although the offset correction processing alone is described here, correction processing for, for example, correction of a missing pixel and gain correction in which gain fluctuations of an amplifier in the radiation detection unit or the like is corrected may be executed.

Those processes of correction processing are not limited to execution in the radiation imaging apparatus 100. For example, the acquired radiographic image and offset image may be transferred to the image control apparatus 500 without being corrected, to receive correction processing in the image control apparatus 500. The offset image used in the offset correction processing may be, for example, an image obtained by processing of reducing noise components through averaging processing or the like with use of a plurality of acquired offset images.

In this embodiment, a radiographic image acquired under control of the radiographic image acquisition control unit 104 receives offset correction executed with use of an offset image acquired by the offset image acquisition control unit 105. However, targets of offset correction are not limited to images. For example, offset correction may be executed for digital data prior to image generation, or may be data obtained by executing the above-mentioned gain correction or the like on the digital data. Those pieces of data can collectively be referred to as “image data” or “offset-corrected data.”

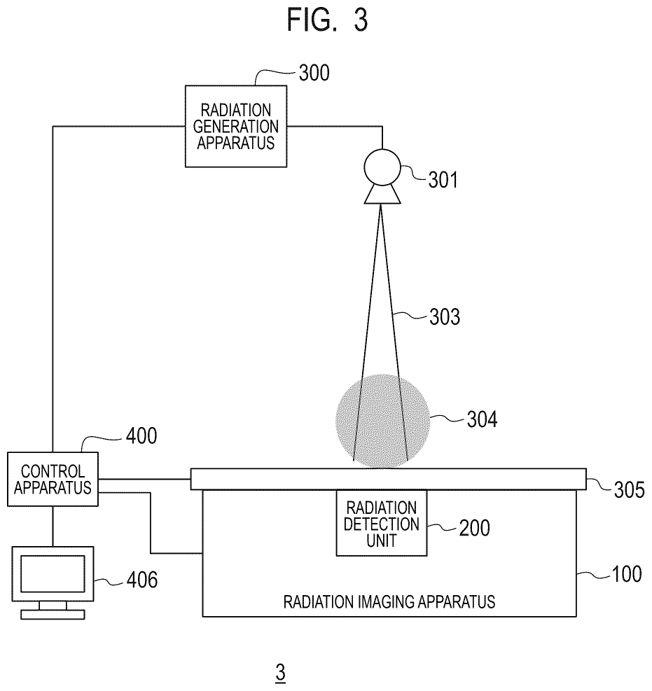

Next, a radiographic testing apparatus 3 to which the radiation imaging system described above is applied is described with reference to FIG. 3. FIG. 3 is a diagram for illustrating a configuration example of the radiographic testing apparatus 3 to which the radiation imaging system according to this embodiment is applied. In FIG. 3, components having the same functions as the functions of the components illustrated in FIG. 1 are denoted by the same reference symbols. In FIG. 3, radiation 303 radiated from a radiation source 301 enters the radiation detection unit 200 through an object 304 which is a target of testing. The object 304 is placed on a conveyance system 305 an example of which is a conveyor belt capable of moving the object 304 by controlling a position of the object 304. The radiation detection unit 200 converts radiation incident through the object 304 and the conveyance system 305 into an electric signal. The control apparatus 400 controls the radiation imaging apparatus 100 so that a radiographic image can be output. The display unit 406 connected to the control apparatus 400 is capable of displaying the acquired radiographic image and photographing information.

In the radiographic testing apparatus 3 illustrated as an example, in a case of photographing (testing) the object 304 and then photographing (testing) another object, the conveyance system 305 is moved to move out the photographed object 304 and place the another object at a testing position. After the objects are switched in this manner, photographing (testing) of the another object is executed. Between testing of the former and testing of the latter, the radiographic testing apparatus 3 is in a state in which no radiation irradiation is taking place. An offset image can accordingly be acquired at this timing. However, a time required to switch objects is short and, in a case in which, for example, there are a plurality of photography modes used in testing, it is not easy to acquire offset images for all of those photography modes.

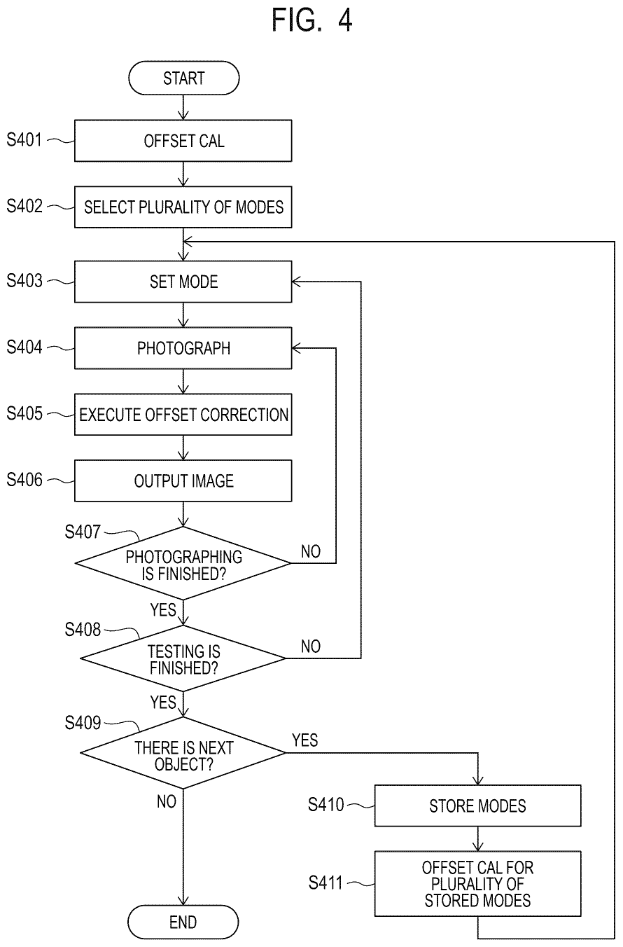

A method of acquiring appropriate offset images in such a short time is described below, with reference to a flow chart illustrated in FIG. 4. FIG. 4 is a flow chart for illustrating a flow of radiograph processing according to a mode of this embodiment. For example, when an instruction to start testing is input from a user to the radiographic testing apparatus 3, drive control of the radiation generation apparatus 300 and the radiation imaging apparatus 100 by the control apparatus 400 is started, and the flow is controlled so as to proceed to Step S401 under control of the drive control unit 102. Sequential execution of subsequent process steps is controlled by the drive control unit 102

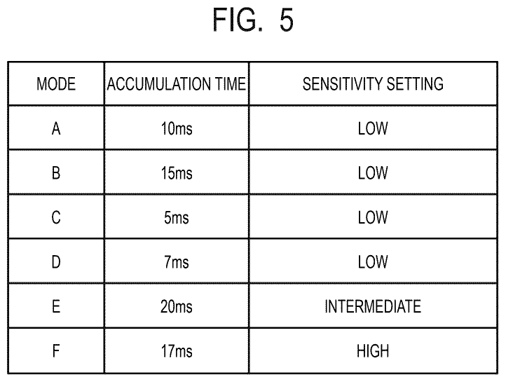

In Step S401, offset images for all photography modes executable in the radiographic testing apparatus 3 are acquired by the offset image update control unit 108, and are stored in the offset image storage portion 111 of the storage unit 109. In this embodiment, the radiographic testing apparatus 3 can use, for example, photography modes that are Mode A to Mode F shown as an example in FIG. 5. Offset images that can be acquired under conditions shown as an example as Mode A to Mode F in FIG. 5 are sequentially acquired in Step S401. In the present disclosure, acquisition of an offset image followed by storing of the acquired offset image is referred to as “offset CAL.” Offset images acquired in Step S401 are set as initial offset images. For example, an initial offset image for Mode A is denoted by OA1. Once initial offset images OA1 to OF1 are acquired, the flow is controlled so as to proceed to Step S402.

In Step S402, the offset image update control unit 108 selects a plurality of photography modes to be used in testing from all photography modes, and sets the number of objects that are targets of the testing. Here, Mode A, Mode B, and Mode C are selected and the number of objects that are targets of the testing is set to 100 for each of the modes, for example. The selection of photography modes and the setting of the number of objects may be executed based on, for example, input by the user via the operation UI 407, or may be executed in accordance with a condition set in advance. Once photography modes are selected and the number of objects is set, the flow is controlled so as to proceed to Step S403.

In Step S403, the offset image update control unit 108 sets a photography mode to be used in photographing out of the plurality of selected photography modes, and sets the number of radiographic images to be photographed in the set photography mode. Here, 50 images are set to be photographed for one object in Mode A, for example. The set photography mode and the set number of images to be photographed are stored in a mode storage portion 1091 provided in the storage unit 109. After the setting of the photography mode in Step S403, the flow is controlled so as to proceed to Step S404.

In Step S404, the radiographic image acquisition control unit 104 causes pixels that are accumulating electric charges to be irradiated with radiation in order to read image data out of the pixels, and the acquired image data is stored in the radiographic image storage portion 110. A radiographic image of the object is thus acquired. Here, a radiographic image acquired first for a first object in Mode A, for example, is referred to as “radiographic image XA1.” Once the radiographic image XA1 is acquired, the flow is controlled so as to proceed to Step S405.

In Step S405, the offset correction unit 107 executes, for the radiographic image XA1 acquired in Step S404, offset correction using the initial offset image OA1 which has been acquired in Step S401. After the execution of the offset correction, in Step S406, an image processed by the offset correction is transferred to the image control apparatus 500 via the communication control unit 112. Here, the image acquired in first-time photographing in Mode A and processed by offset correction, for example, is expressed as (XA1−OA1=) A1. When the image processed by offset correction is output, the flow is controlled so as to proceed to Step S407.

In Step S407, whether photographing is finished is determined by the offset image update control unit 108. When it is determined that photographing is not finished, the flow is controlled so as to return to Step S404. When it is determined that photographing is finished, the flow is controlled so as to proceed to the next step, which is Step S408. Here, in Step S403, 50 images are set to be photographed for the first sample in Mode A. The offset image update control unit 108 accordingly determines whether images A1 to A50 have all been acquired. A state in which the first sample is photographed in Mode A is referred to as “first-time testing of Mode A.” The process steps of from Step S404 to Step S407 are repeated until the image A50 is acquired. When it is determined that the radiographic image A50 has been acquired, the flow is controlled so as to proceed to Step S408 now that photographing of the first object in Mode A is finished,

In Step S408, whether photographing (testing) in the modes selected in Step S402 is finished is determined by the offset image update control unit 108. When it is determined that photographing (testing) is not finished, the flow is controlled so as to return to Step S403. For example, in a case in which photographing is finished for Mode A alone, the flow is controlled so as to return to Step S403 in order to execute photographing in the remaining Mode B and Mode C. When it is determined that the testing is finished, the flow is controlled so as to proceed to the next step, which is Step S409.

For example, consider a case in which 50 images are set to be photographed as first-time testing for every one of Mode A, Mode B, and Mode C selected in Step S402. In this case, in Step S403 returned after the images A1 to A50 are acquired in the photographing mode A, the photographing mode to be used is set to Mode B, and the number of images to be photographed in Mode B is set to 50. Then Step S404 to Step S407 are repeated until images B1 to B50 are acquired in Mode B, and, after Step S408 and Step S403, Step S404 to Step S407 are further repeated until images C1 to C50 are acquired in Mode C. When 50 images are acquired for each of Mode A to Mode C, it means that first-time testing is finished for the modes selected in Step S402. When it is determined in Step S408 that first-time testing is finished, the flow is controlled so as to proceed to Step S409.

In Step S409, the offset image update control unit 108 determines whether there is a next object. When there is a next object, the flow is controlled so as to proceed to Step S410. When there is no more object to be processed, it is determined that photographing is finished for each of the photography modes selected in Step S402, and the radiograph processing is ended. Photographing (testing) in the selected modes is finished for the first object by repetition of Step S402 to Step S408 described above. However, since the number of objects is set to 100 in Step S402, testing is required to be executed for the remaining 99 objects. Accordingly, it is determined in Step S409 that there is a next object, and the flow is controlled so as to proceed to Step S410. When testing is finished with images of Mode A to Mode C acquired for 100 objects, the offset image update control unit 108 determines that there is no more object to be processed.

In Step S410, the plurality of photography modes used in Step S403 to Step S408 are stored in the mode storage portion 1091 by the offset image update control unit 108. In a case in which Mode A, Mode B, and Mode C have been used as the photography modes, for example, the fact that a plurality of modes that are Mode A to Mode C have been used is stored in the mode storage portion 1091. After the photography modes are stored, the flow is controlled so as to proceed to Step S411.

In Step S411, the offset image update control unit 108 acquires the offset images of the photography modes stored in Step S410, and stores the acquired offset images in the offset image storage portion 111 of the storage unit 109. In the example described above, offset images of, for example, the plurality of modes that are Mode A to Mode C stored in the first-time testing are acquired again, and are stored as offset images OA2, OB2, and OC2 in the offset image storage portion 111 of the storage unit 109. When acquisition of offset images of the plurality of stored photography modes is finished, the flow is controlled so as to return to Step S403. Testing of the second object is then executed with the use of the offset images OA2, OB2, and OC2. Subsequently, the update of offset images in Step S411 and the series of process steps of from Step S403 to Step S409 using the updated offset images are repeated in the manner described above. The images A1 to A50, the images B1 to B50, and the images C1 to C50 in the respective modes are thus acquired for the remaining objects, and the testing is completed.

In the example described above, for the respective photography modes, the initial offset images OA1 to OC1 stored in Step S401 in the offset image storage portion 111 are updated to the offset images OA2 to OC2 stored in Step S411. However, in the offset image storage portion 111, the initial offset images OA1 to OC1 and the newly acquired offset images OA2 to OC2 may be stored separately. In Step S401, the drive control unit 102 may acquire gain correction data for all photography modes, and the gain correction data may be stored in the storage unit 109. In Step S410, the plurality of photography modes selected in Step S402 may be stored.

For example, in a case of acquiring images for testing 100 objects in the above-mentioned three modes, some time elapses between acquisition of images of the first object and acquisition of images of the ninetieth objects. A rise in internal temperature of the radiation imaging apparatus 100 that occurs in the elapsed time may cause fluctuations of offset images. Such fluctuations of offset images may result in a failure to execute appropriate offset correction even when offset correction of images of the ninetieth object is executed with the use of the initial offset images described above. The use of an inappropriate offset image may cause, in testing executed in succession, for example, in images acquired in testing of the fourth object and testing of the fifth image, a residual image generated in testing of the fourth object to possibly remain in an image acquired in testing of the fifth object. Specifically, in a case of a residual image generated as an offset component from radiation irradiation of the last time, removal of this residual image may be impossible with the initial offset image acquired in advance in Step S401.

That is, in order to use an appropriate offset image in offset correction, it is preferred to acquire offset images prior to photographing of radiographic images in the respective modes. In the example described above, offset images are preferred to be acquired at timing of Step S410 to Step S411 in a shift from testing of the first object to testing of the second object. In actuality, however, a time available for process steps of from Step S410 to Step S411 is short and, when there are ten photography modes from Mode A to Mode J, for example, acquisition of all offset images for those modes is not practical. In this embodiment, update of required offset images in a limited time in a suitable manner is achieved by storing photography modes used in the immediate last photographing and updating offset images only for the stored photography modes.

As described above, the radiation imaging apparatus 100 according to one embodiment of the present disclosure includes the radiographic image acquisition unit (104), the offset image acquisition unit (105), the offset correction unit (107), the mode storage portion (1091), and the offset image update control unit (108). Although offset correction is executed with the use of a radiographic image and an offset image in the description given above, information usable for offset correction is not limited to images, and may include data from which an image is generated and data obtained by a well- known image processing method. Accordingly, those images are also usable for offset correction as radiographic image data and offset image data. In this embodiment, the radiographic image acquisition control unit 104 functions, in Step S404, for example, as a radiographic image acquisition unit for acquiring radiographic images of a plurality of objects, in a mode selected from a plurality of modes for which different radiographic images are to be acquired. The offset image acquisition control unit 105 functions, in Step S401, for example, as an offset image acquisition unit capable of acquiring an offset image in each of a plurality of modes. The offset image acquisition control unit 105 is capable of acquiring, in Step S411, for example, an offset image for a photography mode set for testing of an object to be tested. The offset correction unit 107 functions, in Step S405, for example, as an offset correction unit for executing offset correction of an acquired radiographic image, with use of an acquired offset image. The mode storage portion 1091 functions, in Step S410, for example, as a mode storage portion for storing a mode selected in order to acquire a radiographic image of an object. The offset image update control unit 108 functions, in Step S411, for example, as an offset image update control unit for controlling the offset image acquisition unit so that an offset image to be used for offset correction is acquired in the stored mode.

The radiation imaging apparatus 100 according to one embodiment of the present disclosure may also be configured so as to include the radiographic image acquisition control unit (104), the offset image acquisition control unit (105), the offset correction unit (107), and the offset image update control unit (108). In this case, the offset image update control unit 108 may control the offset image acquisition control unit 105 so that an offset image in a selected mode is acquired before acquisition of a radiographic image of the next object following one object among a plurality of objects. The acquired offset image is used for offset correction of the next radiographic image.

As described above, the offset image update control unit 108 controls the offset image acquisition control unit 105 so that an offset image used for offset correction is acquired in the stored mode. This acquisition of the offset image is executable after offset correction of a radiographic image acquired in a mode selected for one object among a plurality of objects is finished. The offset image acquired in the stored photography mode is usable for offset correction of a radiographic image of the next object following the one object for which offset correction of the acquired radiographic image is finished.

Execution of the processing described above enables, in testing of a plurality of objects, execution of offset CAL for a plurality of photography modes used in the immediate last testing, by utilizing a time between one session of testing and subsequent session of testing. By thus updating offset images only for photography modes expected to be used, update of offset images is achieved even in a limited time between one session of testing and subsequent session of testing. Accordingly, offset correction can be executed with use of suitable offset images.

### Second Embodiment

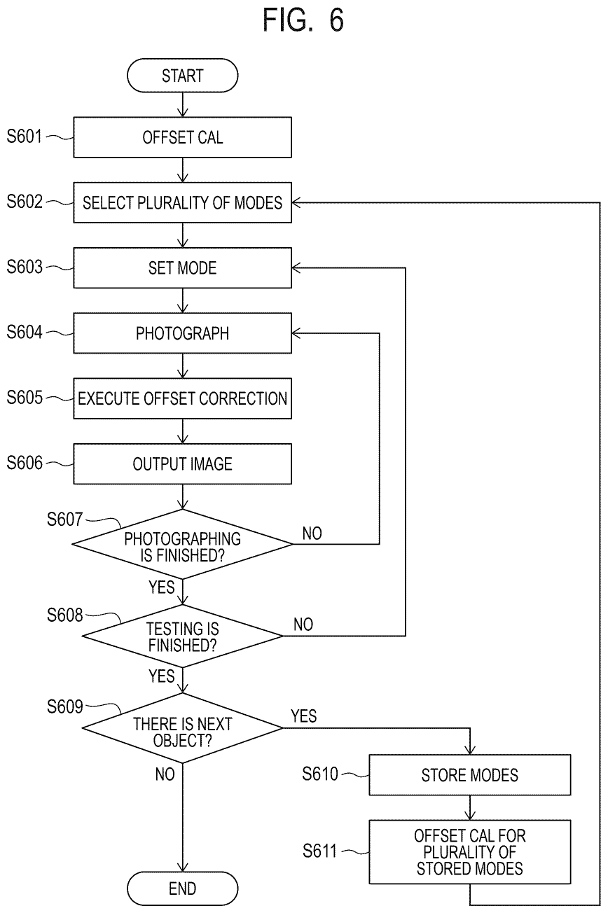

Next, as a second embodiment of the present disclosure, an application example in which a different photography mode is used for each different object is described with reference to FIG. 6. A configuration of the radiation imaging apparatus 100 and a configuration of the radiographic testing apparatus 3 that are used in this embodiment are the same as in the first embodiment, and descriptions thereof are accordingly omitted here. FIG. 6 is a flow chart for illustrating a flow of processing in a case in which a different photography mode may be used for each different object. In the flow chart illustrated in FIG. 4, the same plurality of photography modes are repeatedly executed. In actual testing, however, a different photography mode is selected for each different object in some cases. For example, in first-time testing, Mode A to Mode C are selected and the number of objects (the number of samples) in each mode is set to 100. Normally, the same Mode A to Mode C are selected in second-time and third-time testing, or subsequent sessions of testing, as well. However, there may be a case in which, in the middle of testing of a plurality of objects, Mode A, Mode B, and Mode D are selected in fourth-time testing (a fourth object), for example. Such a case is described below.

In this embodiment, first in Step S601, the offset image update control unit 108 acquires offset images for all photography modes executable in the radiographic testing apparatus 3 and stores the acquired offset images in the offset image storage portion 111. In this embodiment, the radiographic testing apparatus 3 can use, for example, photography modes that are Mode A to Mode F shown in FIG. 5. Offset images that can be acquired under conditions shown as an example as Mode A to Mode F in FIG. 5 are sequentially acquired in Step S601. Once the initial offset images OA1 to OF1 are acquired, the flow is controlled so as to proceed to Step S602.

In Step S602, the offset image update control unit 108 selects a plurality of photography modes to be used in testing from all photography modes, and sets the number of objects that are targets of the testing. In this embodiment, a plurality of photography modes are selected for each session of testing, but it is sufficient to set the number of objects only in the first time. Once photography modes are selected and the number of objects is set, the flow is controlled so as to proceed to Step S603.

In Step S603, the offset image update control unit 108 sets a photography mode to be used in photographing out of the plurality of selected photography modes, and sets the number of images to be photographed in the set photography mode. Here, 50 images are set to be photographed in Mode A, for example. The set photography mode and the set number of images to be photographed are stored in the mode storage portion 1091 provided in the storage unit 109. After the setting of the photography mode in Step S603, the flow is controlled so as to proceed to Step S604.

Process steps of from Step S604 to Step S607 are the same as the process steps of from Step S404 to Step S407 described in the first embodiment, and descriptions thereof are accordingly omitted here. In Step S608, in a case in which 50 images have been acquired in Mode A from the first object, for example, the flow is controlled so as to return to Step S603, in order to set, to the first object, the selected Mode B as the photography mode and acquisition of 50 images. Subsequently, Step S604 to Step S607 are executed and then photographing in Mode C and acquisition of 50 images are further set to the first object in Step S602. When it is determined in Step S608 that 50 images (A1 to A50, B1 to B50, and C1 to C50) have been acquired in this manner for each mode, and that first-time testing is accordingly finished, the flow is controlled so as to proceed to Step S609.

In Step S609, the offset image update control unit 108 determines whether there is a next object (whether second-time testing is to be executed). When there is a next object, the flow is controlled so as to proceed to Step S610. For example, in a case in which images of 100 objects have been acquired in each set mode that is one of the modes selected in Step S602, and testing is finished for 100 objects, the offset image update control unit 108 determines that no object is to be processed next. When it is determined in Step S609 that no object is to be processed next, entire testing is finished.

In Step S610, the plurality of photography modes used in Step S603 to Step S608 are stored in the mode storage portion 1091 by the offset image update control unit 108. In a case in which Mode A, Mode B, and Mode C have been used as the photography modes, for example, the fact that a plurality of modes that are Mode A to Mode C have been used is stored in the mode storage portion 1091. After the photography modes are stored, the flow is controlled so as to proceed to Step S611.

In Step S611, the offset image update control unit 108 acquires the offset images of the photography modes stored in Step S610, and stores the acquired offset images in the offset image storage portion 111 of the storage unit 109. In the example described above, for example, offset images of the plurality of modes stored in the first-time testing which are Mode A to Mode C are acquired again, and are stored as offset images OA2, OB2, and OC2 in the offset image storage portion 111 of the storage unit 109. When the acquisition of offset images of the plurality of stored photography modes is finished, the flow is controlled so as to return to Step S602. Through the series of process steps of from Step S602 to Step S611 described above, the offset images are updated for the second object, and preparations for testing of the second object are completed.

In this embodiment, for example, testing in the plurality of photography modes selected in Step S602 is repeatedly executed for every object. The offset CAL of the plurality of photography modes used the immediate last time is executed in a time between one session of testing and subsequent session of testing, and those offset images are used in the next testing. Here, consider a case in which, as described above, Mode A to Mode C are selected in first-time testing to third-time testing, and Mode A, Mode B, and Mode D are selected as the photography modes in the fourth-time testing. In this case, offset correction of images of the object photographed in Mode D uses an initial offset image OD1 acquired in Step S601.

However, in Step S611 after the fourth-time testing is finished, offset images OA5, OB5, and OD5 acquired in Mode A, Mode B, and Mode D, respectively, are acquired. The offset image OD5 of Mode D acquired in Step S611 is used for offset correction in a case in which Mode D is selected for fifth-time or subsequent testing, for example, sixth-time testing. In this embodiment, testing is completed when testing is finished for 100 objects in every mode selected in Step S602,

In the example described above, the initial offset images stored in Step S601 in the offset image storage portion 111 is updated in each photography mode to the offset images stored in Step S611. However, in the offset image storage portion 111, the initial offset images acquired in the respective photography modes and the offset images newly acquired in the respective photography modes may be stored separately from each other. In Step S601, the drive control unit 102 may acquire gain connection data for every photography mode, and store the gain correction data in the storage unit 109. In Step S610, the plurality of photography modes selected in Step S602 may be stored.

Execution of the steps described above enables execution of offset CAL for a plurality of photography modes used in the immediately preceding testing, by utilizing a time between one session of testing and subsequent session of testing. As a result, by updating offset images only for photography modes expected to be used, update of offset images is achieved even in a limited time between one session of testing and subsequent session of testing. Accordingly, offset correction can be executed with use of suitable offset images.

### Third Embodiment

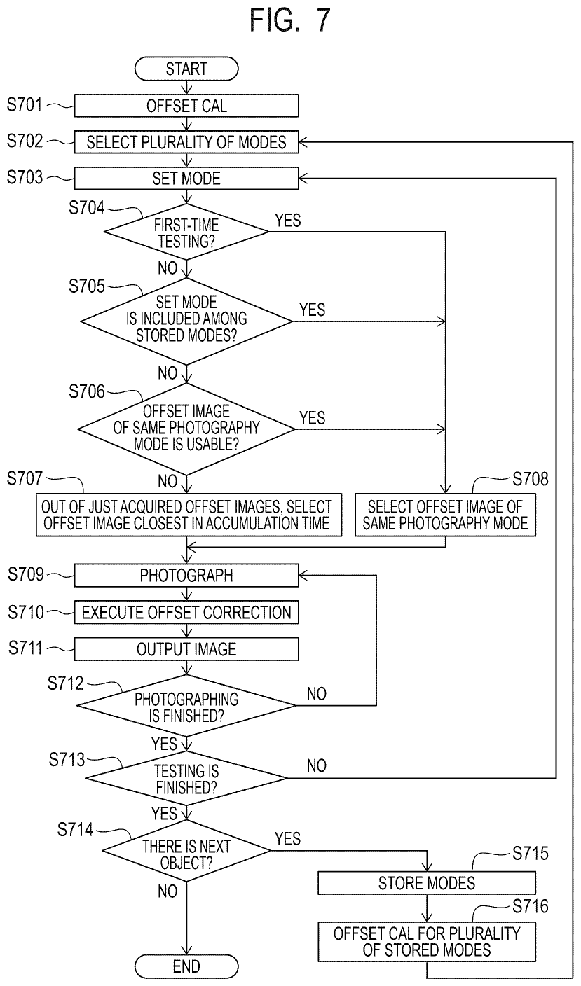

In the second embodiment, the above-mentioned testing that is executed for the first time after Mode D is selected may be affected by offset fluctuations due to an elapse of time since the initial offset image OD1 is acquired. In a third embodiment, with reference to FIG. 7, the following processing is described: offset correction is executed in a suitable manner by selecting an offset image to be used for offset correction in the above-mentioned testing that is executed for the first time after Mode D is selected, for example. A configuration of the radiation imaging apparatus 100 and a configuration of the radiographic testing apparatus 3 that are used in this embodiment are the same as in the first embodiment, and descriptions thereof are accordingly omitted here. FIG. 7 is a flow chart for illustrating a flow of processing in a case in which selecting an offset image is enabled. The following description takes, as an example, a case in which, as in the case of the second embodiment, the number of objects is set to 100, Mode A to Mode C are selected for first-time testing to third-time testing, and Mode A, Mode B, and Mode D are selected as the photography modes in the fourth-time testing.

In this embodiment, process steps of from Step S701, which includes processing of offset CAL, to Step S703, which includes mode setting processing, are the same as the process steps of from Step S601 to Step S603 in the second embodiment. In Step S703, for example, 50 photographed images per object are set to be acquired in Mode A, and the flow is then controlled so as to proceed to Step S704.

In Step S704, the offset image update control unit 108 determines whether this is the first-time testing. When it is determined that this is the first-time testing, the flow is controlled so as to proceed to Step S708. When it is determined that this is not the first-time testing (when the current testing is second-time or subsequent testing), the flow is controlled so as to proceed to Step S7085.

In Step S708, the offset image update control unit 108 selects an offset image of the same photography mode. After the selection, the flow is controlled so as to proceed to Step S709. For example, in the first-time testing, Mode A to Mode C are selected as the plurality of photography modes in Step S702. In a case in which Mode A is set in Step S703, the initial offset image OA1 acquired in Step S701 is selected as the offset image. In the first-time testing, the initial offset images OB1 and OC1 are selected for Mode B and Mode C, respectively, in the same manner.

Process steps of from Step S709 to Step S714 are the same as the process steps of from Step S604 to Step S609 in the second embodiment, except for offset images used in a process step of Step S710. Accordingly, descriptions thereof are omitted here. The offset images used in Step S710 are described later. In Step S714, whether there is a next object is determined. When there is a next object, the flow is controlled so as to proceed to Step S715. In Step S714, whether testing is finished for, for example, 100 objects set in Step S702 is determined. When it is determined in Step S714 that there is an object yet to be tested, the flow is controlled so as to proceed to Step S715.

In Step S715, the plurality of photography modes used in Step S703 to Step S714 are stored in the storage unit 109 by the offset image update control unit 108. In a case in which Mode A, Mode B, and Mode C have been used as the photography modes, for example, the fact that a plurality of modes that are Mode A to Mode C have been used is stored in the mode storage portion 1091. After the photography modes are stored, the flow is controlled so as to proceed to Step S716.

In Step S716, the offset image update control unit 108 acquires offset images of the photography modes stored in Step S715, and stores the acquired offset images in the offset image storage portion 111 of the storage unit 109. In the example described above, for example, offset images of the plurality of modes stored in the first-time testing which are Mode A to Mode C are acquired again, and are stored as offset images OA2,OB2, and OC2 in the offset image storage portion 111. When the acquisition of offset images of the plurality of stored photography modes is finished, the flow is controlled so as to return to Step S702. Through the series of process steps of from Step S709 to Step S715 described above, the offset images are updated for the second object, and preparations for testing of the second object are completed.

When it is determined in Step S704 that testing executed after the mode setting in Step S703 is second-time or subsequent testing, the flow is controlled so as to proceed to Step S705. In the second-time testing and subsequent testing, the offset image update control unit 108 determines, in Step S705, whether the photography mode set in Step S703 by the offset image update control unit 108 is included among the plurality of photography modes stored in Step S715. When it is determined that the set photography mode is included, the flow is controlled so as to proceed to Step S708. When it is determined that the set photography mode is not included, the flow is controlled so as to proceed to Step S706.

Here, photographing in Mode A to Mode C is executed in the third-time testing and Mode A, Mode B, and Mode D are selected in Step S702 in the fourth-time testing, for example. In a case in which Mode D is set as the photography mode in Step S703 of the fourth-time testing, it is determined in Step S705 that Mode D which is the set photography mode is not included among Mode A to Mode C stored in Step S715, and the flow is controlled so as to proceed to Step S706.

In Step S706, the offset image update control unit 108 determines whether the offset image of the same photography mode that has been acquired in advance is usable. When the offset image is determined to be usable, the flow is controlled so as to proceed to Step S708. When the offset image is determined to be unusable, the flow is controlled so as to proceed to Step S707. For example, as described above, photographing in Mode A to Mode C is executed in the first-time testing to the third-time testing, and Mode A, Mode B, and Mode D are selected as the photography modes in Step S702 in the fourth-time testing. In Step S706, whether the offset image (OD1) of the same mode that has been acquired in Step S701 is usable for radiographic images acquired in Mode D is determined.

An example of a method of determination executed in Step S706 is described next. As the method of the determination, for example, an offset image of a mode highest in sensitivity setting or an offset image of a mode shortest in accumulation time is selected first out of the offset images OA4, OB4, and OC4 acquired in Step S716 after the third-time testing. According to the example shown in FIG. 5, in this case, the determination is executed with use of the offset image photographed in Mode C.

The following calculation, for example, is usable to execute specific determination processing. That is, an average value of all pixels of the offset image OC4 is given as OC4ave, and an average value of all pixels of the initial offset image OC1 is given as OC1ave. A difference between the two is given as OC41ave (OC41ave=OC4ave−OC1ave). Next, a difference between the offset image OC4 and the initial offset image OC1 is obtained. A resultant image is an image OC41. An image generated from a difference between the image OC41 and the pixel value OC41ave is given as a residual image determination image OC41z (OC41z=OC41−OC41ave). Pixel values are plotted along a horizontal direction of an image center portion of the residual image determination image OC41z. When it is found out as a result that ten or more successive pixels have a pixel value equal to or more than ±100 LSB from reference 0 LSB, it is determined that there is a residual image.

In that case, the offset image OC4 is determined to have the residual image, and it is accordingly determined that, for radiographic images acquired in Mode D, the offset image OD1 of the same mode is unusable. Then the flow is controlled so as to proceed to Step S707. When the offset image OC4 is determined to have no residual image, the determination that there is no residual image is likely to be made also for an image generated from a difference between an offset image expected to be acquired in Mode D at timing at which the offset image OC4 is acquired and the initial offset image OD1. It is accordingly determined that the offset image OD1 photographed in Mode D which is the same photography mode is usable, and the flow is controlled so as to proceed to Step S708.

In Step S707, the offset image update control unit 108 selects, as an offset image to be used in Mode D, an offset image closest in accumulation time out of the offset images acquired in Step S716. After the selection, the flow is controlled so as to proceed to Step S709.

The description given here takes, as an example, a case in which Mode A to Mode C are selected in the third-time testing, and Mode A, Mode B, and Mode D are selected in the fourth-time testing. In this case, Mode D is set as the photography mode in Step S703 of the fourth-time testing. When it is determined in Step S706 that the offset image OD1 of the same photography mode is unusable, this embodiment uses one of the just acquired offset images OA4, OB4, and OC4 to execute offset correction. In this embodiment, which one of the three offset images is to be selected is based on accumulation time, and an offset image acquired in a mode closest in accumulation time to Mode D is selected. For example, according to FIG. 5, the accumulation time is 10 ms in Mode A, 15 ms in Mode B, 5 ms in Mode C, and 7 ms in Mode D. In this case, Mode C is closest in accumulation time to Mode D with regards to the offset image. Consequently, the offset image OC4 is used to execute offset correction of radiographic images photographed in Mode D in the fourth-time testing.

In Step S706 described above, the determination on whether an offset image of the same photography mode is usable may be based on offset fluctuations. In this case, a variation rate of an average value of the pixel value of the initial offset image and the pixel value of a just acquired offset image is calculated first. When the variation rate is equal to or more than a threshold value, it is determined that there are offset fluctuations. For instance, in the example described here, the initial offset image OA and the offset image OA4 acquired in Step S716 after the third-time testing are used to compare the variation rate of the average value and the threshold value. When the variation rate of the average value is ±20% or higher, it is determined that there are offset fluctuations. The value used for this determination is not limited to the variation rate given as an example, and a pixel value as a result of differencing may be used. In this case, when the pixel value as a result of differencing is equal to or more than a threshold value, it is determined that there are fluctuations. Further, the determination on offset fluctuations and the determination on a residual image which are described above may be combined to execute the process step of Step S706. Alternatively, using only one of the two may be chosen.

In a case in which the determination in Step S706 is based on the presence or absence of a residual image, one place or a plurality of places in an image may be used for the determination. In a case in which a plurality of places are used for the determination, it is determined that there is a residual image when ten or more successive pixels have a pixel value equal to or more than ±100 LSB from reference 0 LSB in any one of the plurality of places. In this case, the residual image determination can be made by plotting pixel values in a horizontal direction of the residual image determination image OC41z, in three places that are ¼, 2/1, and ¾ in a vertical direction of OC41z.

Step S706 described above may be omitted. In a case in which the set photography mode is not included among the plurality of photography modes used in the immediately preceding testing, the flow may proceed to Step S708 without executing determination on the just acquired offset image.

When it is found out in Step S707 described above that there are a plurality of modes that are closest in accumulation time, a most recently acquired offset image of a photography mode may be chosen to be used out of the offset images updated in Step S716. Alternatively, an offset image of a photography mode closest in sensitivity setting may be used, or a combination of those may be used. When it is found out that there are a plurality of modes that are closest in sensitivity setting, a most recently acquired offset image of a photography mode may be chosen to be used out of the offset images updated in Step S716.

In a case in which an offset image of a photography mode closest in accumulation time is selected in Step S707 described above, but the photography mode to be used differs in sensitivity setting, correction may be executed so that a match to the sensitivity setting of the photography mode to be used is achieved. For example, the offset image OB4 is selected for offset correction of a photography mode E in the fourth-time testing. In this case, the pixel value may be multiplied by a ratio of intermediate sensitivity and low sensitivity as a coefficient so that the offset image OB4 has the same sensitivity setting as the sensitivity setting (“intermediate” in the example of FIG. 5) of the photography mode E.

As described above, in the radiation imaging apparatus according to this embodiment, a case in which, when acquiring radiographic image data of a next object following one object, a mode that is not stored in the mode storage portion 1091 is selected from a plurality of modes is assumed as well. In such a case, an offset image acquired in the mode that is not stored in the mode storage portion 1091 is selected from a plurality of offset images (OA1 to OF1) acquired in respective modes of the plurality of modes. The offset correction unit 107 can execute offset correction with the use of the selected offset image. In this case, there is further an option of selecting an offset image acquired in a mode closest in at least one of accumulation time and sensitivity setting to a mode stored in the mode storage portion 1091, out of the plurality of modes. The offset correction unit 107 can execute offset correction with the use of the selected offset image. Alternatively, there is another option of selecting an offset image acquired in a mode that is selected in acquisition of a radiographic image of the next object, out of the plurality of offset images acquired in respective modes of the plurality of modes. The offset correction unit 107 can execute offset correction with the use of the selected offset image.

In this embodiment, the offset image update control unit 108 can further determine whether there is a residual image in an offset image acquired in a mode stored in the mode storage portion 1091 before acquisition of radiographic image data of the next object. When it is determined that there is a residual image, an offset image acquired in a mode closest in at least one of accumulation time and sensitivity setting to the mode stored in the mode storage portion 1091, out of the plurality of modes, may be selected. The offset correction unit 107 can execute offset correction with the use of the selected offset image. The offset image update control unit 108 may also obtain a variation rate of offset images by comparing an offset image acquired in a mode stored in the mode storage portion 1091 before acquisition of a radiographic image of the next object, and an offset image acquired in a mode selected before acquisition of a radiographic image of the one object. When the variation rate is equal to or more than a threshold value, there is an option of selecting an offset image acquired in a mode closest in at least one of accumulation time and sensitivity setting to the mode stored in the mode storage portion 1091, out of the plurality of modes. The offset correction unit 107 can execute offset correction with the use of the selected offset image.

As described above, the present disclosure may configure the radiation imaging system 1 or the radiographic testing apparatus 3. In this case, the radiation imaging system 1 or the radiographic testing apparatus 3 includes the radiation generation apparatus 300, the control apparatus 400, and the radiation imaging apparatus 100 described above. In the embodiments described above, the radiation generation apparatus 300 functions as a radiation generation apparatus that generates radiation in the present disclosure. The control apparatus 400 functions as a control apparatus for controlling the radiation generation apparatus 300.

A method of determining which offset image is to be selected is obtained by executing the steps described above. As a result, offset correction can be executed with use of an optimum offset image even when a photography mode different from a plurality of photography modes used in the immediately preceding testing is set.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-180176, filed Oct. 19, 2023, which is hereby incorporated by reference herein in its entirety.

What is claimed is:

1. A radiation imaging apparatus comprising:
a radiographic image acquisition unit configured to acquire radiographic image data of a plurality of objects in a mode selected from a plurality of modes for acquiring different radiographic images;
an offset image acquisition unit configured to acquire offset image data in each of the plurality of modes;
an offset correction unit configured to execute offset correction of the acquired radiographic image data with use of the acquired offset image data;
a mode storage portion configured to store a mode selected in order to acquire the radiographic image data of the plurality of objects; and
an offset image update control unit configured to control the offset image acquisition unit so that the offset image data to be used for the offset correction is acquired in the stored mode.

2. A radiation imaging apparatus according to claim 1, wherein the offset image update control unit is configured to control the offset image acquisition unit so that the offset image data to be used for the offset correction is acquired in the stored mode, after offset correction is finished for the radiographic image data acquired in the selected mode with respect to one object out of the plurality of objects.

3. A radiation imaging apparatus according to claim 2, wherein the offset image data acquired in the stored photography mode is used for offset correction of the radiographic image data of a next object following the one object for which the offset correction of the acquired radiographic image data is finished.

4. A radiation imaging apparatus according to claim 2, wherein, in a case in which, in acquisition of the radiographic image data of a next object following the one object, a mode that is not stored in the mode storage portion is selected from the plurality of modes, the offset correction unit is configured to execute the offset correction by selecting the offset image data acquired in the mode that is not stored in the mode storage portion, out of a plurality of pieces of offset image data acquired by the offset image acquisition unit in respective modes of the plurality of modes.

5. A radiation imaging apparatus according to claim 4, wherein the offset correction unit is configured to execute the offset correction by selecting the offset image data acquired in a mode that is closest in at least one of accumulation time and sensitivity setting to the mode stored in the mode storage portion, out of the plurality of modes.

6. A radiation imaging apparatus according to claim 4, wherein the offset correction unit is configured to execute the offset correction by selecting the offset image data acquired in a mode selected in acquisition of the radiographic image data of the next object, out of the plurality of pieces of offset image data acquired by the offset image acquisition unit in respective modes of the plurality of modes.

7. A radiation imaging apparatus according to claim 4,
wherein the offset image update control unit is configured to determine whether there is a residual image in the offset image data acquired in the mode stored in the mode storage portion before acquisition of the radiographic image data of the next object, and
wherein, when it is determined that there is a residual image, the offset correction unit is configured to execute the offset correction by selecting the offset image data acquired in a mode that is closest in at least one of accumulation time and sensitivity setting to the mode stored in the mode storage portion, out of the plurality of modes.

8. A radiation imaging apparatus according to claim 4,
wherein the offset image update control unit is configured to obtain a variation rate of an offset image by comparing the offset image data acquired in the mode stored in the mode storage portion before acquisition of the radiographic image data of the next object, and the offset image data acquired in the selected mode before acquisition of the radiographic image data of the one object, and
wherein, when the variation rate is equal to or more than a threshold value, the offset correction unit is configured to execute the offset correction by selecting the offset image data acquired in a mode that is closest in at least one of accumulation time and sensitivity setting to the mode stored in the mode storage portion, out of the plurality of modes.

9. A radiation imaging apparatus comprising:
a radiographic image acquisition unit configured to acquire radiographic image data of a plurality of objects in a mode selected from a plurality of modes for acquiring different radiographic images;
an offset image acquisition unit configured to acquire offset image data in each of the plurality of modes;
an offset correction unit configured to execute offset correction of the acquired radiographic image data with use of the acquired offset image data; and
an offset image update control unit configured to control the offset image acquisition unit so that the offset image data in the selected mode is acquired before the radiographic image data of a next object following one object among the plurality of objects is acquired, for the offset correction of the radiographic image data of the next object.

10. A radiation imaging system comprising:
a radiation generation apparatus configured to generate radiation;
a control apparatus configured to control the radiation generation apparats; and
the radiation imaging apparatus according to claim 1.

11. A method of controlling a radiation imaging apparatus comprising:
acquiring radiographic image data of an object in a mode selected from a plurality of modes for acquiring different radiographic images;
acquiring offset image data in each of the plurality of modes;
executing offset correction of the acquired radiographic image data with use of the acquired offset image data;
storing a mode selected in order to acquire the radiographic image data of the object; and
reacquiring the offset image data to be used for the offset correction, in the stored mode.

12. A non-transitory tangible medium having recorded thereon a program for causing a computer to perform steps of the method according to claim 11.
